(19) United States
(12) Patent Application Publication
(10) Pub. No.: US 2026/0057724 A1
(43) Pub. Date: Feb. 26, 2026

(54) COIN MEDIA PATH AGITATION

(71) Applicant: NCR Atleos Corporation, Atlanta, GA (US)

(72) Inventors: Paul David Rutherford, Dundee (GB); Douglas Ronald Allan, Perth (GB); Adam Delaney Boyd, Dundee (GB); Liam Fraser Mccafferty, Dundee (GB)

(21) Appl. No.: 18/814,852

(22) Filed: Aug. 26, 2024

(51) Int. Cl. G07D 1/06

(52) U.S. Cl. CPC G07D 1/06; G07D 2201/00

(57) ABSTRACT

A vibrating coin chute system for automated teller machines (ATMs) and self-service terminals (SSTs) is provided to improve coin dispensing reliability. The system incorporates a small vibration motor encapsulated within a plastic part in the coin path, activated by detecting power draw during transactions. The system reduces jams by maintaining coin momentum through complex chute designs, especially beneficial in compact ATMs/SSTs with long horizontal coin paths. The vibration motor, triggered without software control, continues running briefly after dispensing to ensure complete coin evacuation. The system significantly improves coin dispensing efficiency, reduces service calls, and enhances customer experience. The system's design considers electromagnetic compatibility (EMC) and electrostatic discharge (ESD) risks and allows for universal application across various ATM/SST models, addressing the challenges of coin dispensing in modern, space-constrained terminals.

### BACKGROUND

Modern automated teller machines (ATMs) and self-service terminals (SSTs) face significant challenges in reliably dispensing coins, particularly in compact designs where space constraints necessitate complex coin paths. These intricate routes can cause coins to lose momentum, especially lighter denominations, leading to jams and blockages. Such issues result in poor customer experiences, increased service calls, and higher maintenance costs. The problem is exacerbated in newer ATM models where elaborate chute designs are required to route coins from deeply positioned modules to the fascia, often requiring coins to travel long horizontal distances with limited vertical drop. These design constraints can significantly impact the reliability of coin dispensing, potentially putting units out of service and incurring substantial operational costs for financial institutions and ATM operators.

### BRIEF DESCRIPTION OF THE DRAWINGS

FIG. 1 is a diagram of a side view of coin media path agitation apparatus, according to an example embodiment.

FIG. 2 is diagram of a front view of a coin media path agitation apparatus, according to an example embodiment.

FIG. 3 is diagram of a system for coin media path agitation, according to an example embodiment.

FIG. 4 is a flow diagram of a method of operating a media terminal with coin media path agitation, according to an example embodiment.

### DETAILED DESCRIPTION

Modern coin dispensing machines in automated teller machines (ATMs) and self-service terminals(SSTs) face numerous challenges that impact their reliability and efficiency. These issues are particularly pronounced in compact, modern ATM designs where space constraints necessitate complex coin paths. In such configurations, coins often need to travel long horizontal distances, sometimes up to 500 mm, with limited vertical drop. This extended travel path, combined with the diverse characteristics of different coin denominations and currencies, can lead to significant dispensing problems.

One of the primary issues is the loss of momentum experienced by coins as they traverse these complex paths. Lighter weight coins, such as 1 cent pieces or dimes, are especially susceptible to slowing down or coming to a complete stop when encountering sharp turns or changes in chute width. This loss of momentum can result in coins failing to reach the customer, creating blockages within the ATM that require service intervention. The problem is exacerbated in newer ATM models where coin modules are positioned deeper within the machine due to the increased number of features and modules competing for space behind the fascia.

These design constraints significantly impact the reliability of coin dispensing operations. When coins fail to dispense properly, it leads to poor customer experiences, increased frequency of service calls, and higher maintenance costs for financial institutions and ATM operators. Moreover, these issues can potentially put ATM units out of service, resulting in substantial operational costs and lost transaction opportunities.

Embodiments of the present invention address these challenges through the innovative application of vibration technology to the coin dispensing process. The technique involves integrating one or more small vibration motors within the coin chute, particularly in areas prone to jamming. These motors, when activated, create resonating vibrations throughout the coin chute, helping to maintain the coins' momentum and prevent them from becoming jammed against each other or the chute walls.

In an embodiment, a vibration motor is strategically integrated into a small plastic part within the coin chute, particularly in areas prone to jamming. This plastic component not only encapsulates the motor but also serves a dual purpose by providing a disruptive path for the media, ensuring proper coin alignment as they approach the exit path through the fascia. The motor itself is compact, typically a 7 mm 5V DC coreless motor similar to those found in electric toothbrushes or mobile devices. This small size allows for seamless integration into the confined spaces of modern ATM designs. The motor's placement is carefully chosen to maximize its effect on coin movement, particularly in horizontal sections or areas with sharp turns where coins are most likely to lose momentum.

The system is designed to operate intelligently, activating only when needed during a transaction. This is achieved through a circuit that monitors the power draw of the coin dispensing module, triggering the vibration motor when a significant current is detected, indicating an ongoing transaction. The motor continues to run for a short period after the transaction completes, ensuring all coins have successfully traversed the chute.

This solution significantly improves coin dispensing efficiency, with testing showing up to a fivefold improvement in Mean Pulls to Failure (MPF) compared to systems without vibration. By maintaining coin momentum through complex chute designs, the embodiment allows for more flexible ATM layouts, including those with lower gradients and sharper turns in the coin path. This flexibility in design is particularly beneficial for compact ATMs where space optimization is crucial.

Testing of the coin media path agitation apparatus has shown remarkable improvements in coin dispensing efficiency. In some cases, the Mean Pulls to Failure (MPF) increased by more than 5 times compared to systems without vibration. This significant improvement demonstrates the effectiveness of the vibration technology in maintaining coin momentum and preventing jams, even in complex chute designs with lower gradients and sharper turns.

Furthermore, embodiments of the invention address potential electromagnetic compatibility (EMC) and electrostatic discharge (ESD) concerns through careful design considerations. The use of a coreless motor with low electromagnetic interference (EMI) characteristics, combined with encapsulation in ABS molding and a grounded stainless steel surface, minimizes these risks.

By tackling the core issues of coin dispensing in modern ATMs, embodiments of this invention not only improve operational reliability but also enhance customer experience, reduce maintenance costs, and provide greater flexibility in ATM design and placement.

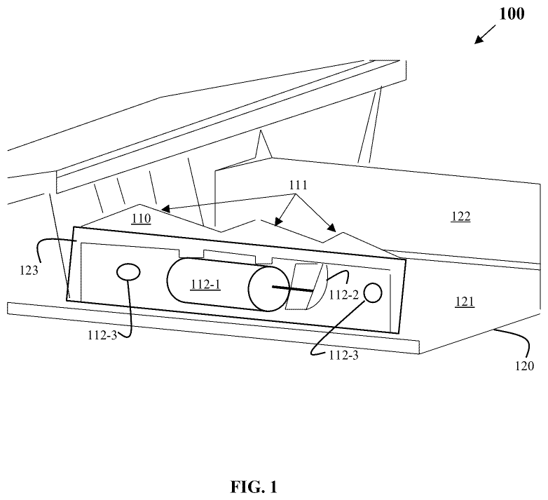

FIG. 1 is a diagram of a side view of coin media path agitation apparatus 100, according to an example embodiment. Notably, the components are shown schematically in simplified form, with only those components relevant to understanding of the embodiments being illustrated.

Furthermore, the various components (that are identified in apparatus 100) are illustrated and the arrangement of the components are presented for purposes of illustration only. Notably, other arrangements with more or less components are possible without departing from the teachings of coin media path agitation, presented herein and below.

Apparatus 100 is integrated into an existing coin path of a coin dispenser of a media terminal. The location of the coin path can vary based on experienced coin jams occurring along the coin path of the coin dispenser. Typically, and because of modern designs in compact media terminals, the location along the coin path, which causes the most problems in properly moving the coins along the path, is located just before a coin bowl or receptacle located outside of a facia for the media terminal. This location is often horizontal and narrow in width and is referred to as the coin chute. As a result, coins lose momentum and remain stuck in the coin chute. Furthermore, the horizontal nature of the coin chute almost forces lager coins to exit individually into the coin bowl which can also cause coins to jam before exiting the fascia into the coin bowl.

In an embodiment, the apparatus 100 is a modified and enhanced version of an existing coin chute. The apparatus 100 is integrated into a portion of the coin path. The portion is a last leg of the coin path (i.e., coin chute) before coins are ejected through the fascia of the media terminal into the coin bowl.

The apparatus 100 includes a sawed toothed deflector sidewall 110, which includes a plurality of sawed toothed deflector members 111, a small vibrating motor 112-1 recessed into a backside of the sawed toothed deflector sidewall 110. The vibrating motor 112-1 further includes a protruding member 112-2 that rotates against the backside of the sawed toothed deflector sidewall 110 when the vibrating motor 112-1 is provided power. This causes vibrations of the sawed toothed deflector sidewall 110 and vibrations along the horizontal coin path 121. The sawed toothed deflector members 111 facilitate continuous and uninterrupted movement of the coins along path 121 to exit at an end 120 of the coin path 121, through the fascia the media terminal, and into the coin bowl preventing coin jams and coin backups. Furthermore, coins of small size and mass, such as dimes or pennies, are moved along substantially horizontal coin path 121 by the vibrations to exit the end location 120 through the facia and into the coin box for customer retrieval.

The resonating vibrations through the apparatus 100 (e.g., enhanced coin chute) helps stop the coins from slowing down and becoming jammed against each other or their surroundings. This creates a similar effect to vibratory sorting machines of conveyor belt. The result of the continuous vibrations experienced by coin path 121 is that the coin media's movement is fluid and continuous until the coins exit at end location 120 through the media terminal's fascia and drop into the coin box for customer retrieval.

In an embodiment, the small vibrating motor 112-1 is integrated into any problematic area along the coin's media path. In an embodiment, multiple 112-1 are situated along multiple problematic areas along the coin's media path.

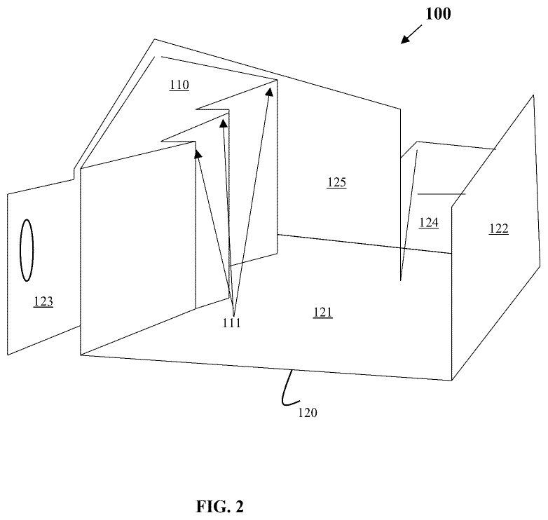

FIG. 1 shows a transparent view of sidewall 123 such that a backside of sawed toothed deflector sidewall 110 is visible. A non-transparent view of sidewall 123 is shown in FIG. 2 discussed below.

The sawed toothed deflector sidewall 110 is affixed to a sidewall 123 via receptacles or apertures 112-3 manufactured within sawed toothed deflector sidewall 110. The receptacles or apertures are drilled through sidewall 123 and screws, bolts, wingnuts, etc. are inserted through the sidewall holes into receptacles 112-3 to affix sawed toothed deflector sidewall 110 securely to sidewall 123 against an inside surface of sidewall 123. The partial hollow backside of the sawed toothed deflector sidewall 110 includes the small vibration motor 112-1 and its protruding and rotating member 112-2.

As a result, sawed toothed deflector sidewall 110 and small vibrating motor 112-1 are easily integrated into any existing coin chute of any existing media terminal. This is achieved via attaching sawed toothed deflector sidewall 110 with small vibrating motor 112-1 to one of the existing coin chute's sidewalls, such as sidewall 123.

FIG. 2 is diagram of a front view of a coin media path agitation apparatus 100, according to an example embodiment. FIG. 2 more clearly illustrates three side walls 122, 123, and 125 that enclose coin path 121. Sawed toothed deflector sidewall 110 is affixed to side wall 123, as was discussed above with FIG. 1.

Coins enter from a preceding coin path of the media terminal onto coin path 121 via entry location 124. As the coins enter coin path 121 protruding and rotating member 112-2 hits, abuts, or vibrates against a backside of sawed toothed deflector sidewall 110 and an inside of sidewall 123. This causes movement in the sawed toothed deflector members 111 and vibrations along metalwork of coin path 121 which urge the coins to separate and move past exit end 120 of the coin path 121, through the media fascia, and into a coin bowl where the coins are retrieved by a customer performing a transaction at the media terminal. A frequency of the vibrations travels up the coin path 121 of apparatus 100 (e.g., enhanced coin chute) through the contacting metalwork, which alleviates coin jams and provides a fluid and constant movement of the coins to exit of end location 124 of coin path 121 through the media terminal's fascia and into coin bowl for customer retrieval during a transaction at the media terminal.

While the current embodiment utilizes a circuit or PCB to control the vibration motor, there is potential for further optimization through software control. Enhanced software could potentially leverage greater results by dynamically adjusting the vibration intensity or duration based on real-time transaction data, coin denominations being dispensed, or historical jam data for specific coin paths. This software-driven approach could provide even more precise control over the coin dispensing process, further improving reliability and efficiency. In an embodiment, a self-calibration processor is implemented and based on the principle of mechanical resonance. This process incrementally adjusts the vibration frequency while monitoring the amplitude of mechanical vibrations to identify the coin chute's resonant frequency, where the vibration is maximized.

In an embodiment, the small vibrating motor 112-1 is powered on and activated based on a state of the coin dispenser. In an embodiment, a circuit or printed circuit board (PCB) is integrated into a power feed of the coin dispenser and just powers the small vibration motor 112-1 when a significant draw is detected, which indicates a transaction is taking place on the media terminal. The circuit or PCB continues to power and run the small vibrating motor 112-1 for a preconfigured amount of time after power usage to the coin dispenser, to ensure that all coin media has evacuated the apparatus 100 (e.g., enhanced coin chute). Experimentation has indicated that coins can travel as far as 500 mm or more to end location 120 along coin path 121. Thus, in this embodiment, no software control is needed to implement the teachings presented herein; rather, a circuit or PCB board detects power draw to the coin dispenser to activate and deactivate power and activation to small vibrating motor 112-1.

In an embodiment, the small vibrating motor 112-1 is activated when expect coin weights or an expected number of coins are not detected as having exited apparatus 100 (e.g., enhanced coin chute) within a predefined transaction time for the transaction. In this embodiment, image and or weight sensors combined with enhanced software are used to intermittently power on and activate small vibrating motor 112-1 when it is determined necessary to do so.

The design of the coin media path agitation apparatus 100 takes into account the diverse characteristics of different currencies and coin denominations. Considerations such as coin size, weight, and material composition are factored into the placement and intensity of the vibration motors. For example, lighter coins like 1 cent pieces or dimes may require more intense vibration to maintain momentum, while heavier coins may need less. This adaptability ensures that the system associated with apparatus 100 can effectively handle a wide range of currencies and denominations, making it suitable for use in various international markets and multi-currency ATMs. In an embodiment, a calibration process is implemented to determine an optimal vibration frequence for each unique coin chute based on the principle of mechanical resonance, ensuring maximum efficiency for each specific coin path configuration.

In an embodiment, the locations of one or more small vibrating motors 112-1 along the media terminal's internal coin path are determined based on path section lengths, gradients, and curvatures/turns in particular path sections. In an embodiment, sawed toothed deflector sidewall 110 along with small vibrating motor 112-1 is integrated into an enhanced coin chute (e.g., apparatus 100) with one or more other small vibrating motors 112-1 are situated along problematic sections of the media terminal's internal coin path. The additional small vibrating motors 112-1 are encapsulated and integrated into sidewalls along the media terminal's problem coin path sections. Again, and in some embodiments, no software or software control is needed to activate these additional small vibrating motors 112-1 since a circuit or PCB can activate the additional small vibrating motors based on power draw to the media terminal's coin dispenser.

Apparatus 100 is easily integrated into existing media terminal coin paths with low expense and integration time required. Moreover, newer more compact designs of media coin paths are capable of being provided with integration of apparatus 100. For example, lower path gradients and sharper turns than exist today in media terminals for coin paths can be incorporated to provide the shortest coin path route through the media terminal's fascia to the coin box, with confidence that light weight coins and larger coins will not get stuck in a more compact and efficient coin path design within media terminals.

Furthermore, apparatus 100 provides increased reliability of functional purpose for coin chutes of media terminals. Additionally, eliminated coin cute blockages are eliminated or substantially reduced meaning customers receive their correct change during a transaction at a media terminal. Service calls related to coin blockages are reduced and existing designs of media coin chutes do not require modification; rather apparatus 100 can be retrofitted and integrated into existing coin chute designs inexpensively, quickly, and with little labor required. The existing design of the coin chute is not compromised with integration of apparatus 100. Furthermore, apparatus 100 is capable of being integrated into any existing coin chute design.

In an embodiment, the small vibrating motor 112-1 is a 7 mm 5V DC coreless motor. This is similar to what is found in electric toothbrushes and mobile devices. This is inexpensive and readily available in the industry.

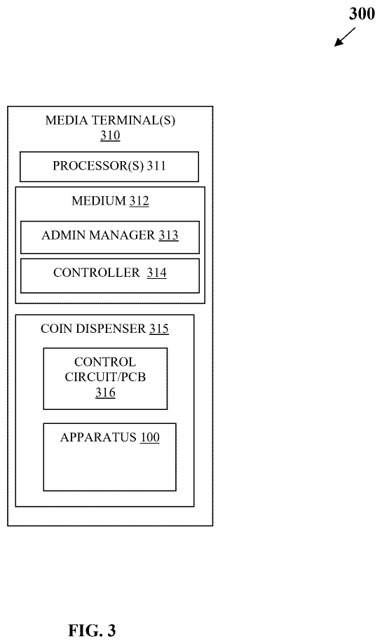

FIG. 3 is diagram of a system 300 for coin media path agitation, according to an example embodiment. Notably, the components are shown schematically in simplified form, with only those components relevant to understanding of the embodiments being illustrated.

Furthermore, the various components (that are identified in apparatus 100) are illustrated and the arrangement of the components are presented for purposes of illustration only. Notably, other arrangements with more or less components are possible without departing from the teachings of coin media path agitation, presented herein and below.

System 300 includes a media terminal 310. The media terminal 310 includes at least one processor 311 and a non-transitory computer-readable storage medium 312, which includes instructions for an administrative manager 313 and a controller 314. The instructions when executed by processor 311 cause processor 311 to perform operations discussed herein and below with respect to admin manager 313 and controller 314.

Media terminal 310 further includes a coin dispenser 315. Coin dispenser 315 includes a control circuit and/or PCB 316 and apparatus 100 as discussed above with FIGS. 1 and 2.

Notably, media terminal 310 includes a variety of other modules or devices not illustrated in system 300. For example, media terminal 310 includes a note or bill module, which includes note or bill media cassettes, note or bill upper and lower transports, a note or bill infeed module, and a note or bill outfeed module (e.g., the outfeed module may be integrated with the infeed module as one infeed and outfeed module). Media terminal 310 also includes note or bill validation modules and/or sensors, a note or bill deskew module, a note or bill rejection bin or module, and an optional note or bill recycler module. Other media terminal peripheral devices or modules include, by way of example only, a contact-based or contactless card reader, a touch display, a scanner, a weigh scale, a combined scanner and weigh scale, an encrypted personal identification number (PIN) pad, wireless transceivers, a bag scale, and other peripherals.

Coin dispenser 315 includes a control circuit and/or PCB 316 and apparatus 100. In an embodiment, control circuit 316 is integrated into a power feed of coin dispenser 315 causing activation of small vibrating motor 112-1 of apparatus 100 when a transaction is initiated on media terminal 310, the control circuit 316 continues to power small vibrating motor 112-1 for a preconfigured of time after the power draw stabilizes for the coin dispenser 315. In an embodiment, the preconfigured period of time is approximately 3 seconds after a last coin is dispensed into a coin bowl outside the fascia of the media terminal 310. This allows time for the coins to travel and exit into the coin bowl.

Coin dispenser 315 includes a variety of other devices, modules, or components not illustrated in FIG. 3. For example, the coin dispenser 315 includes a coin hopper, a coin escrow, a coin sorter, a coin validator, a coin transport along the coin media path, sensors, coin rejection slot, and others.

In an embodiment, PCB 316 determines when a motor of the coin hopper is running indicating that a transaction is being processed on media terminal 310. PCB 316 causes small vibrating motor 112-1 to be powered on and activated, the PCB 316 also ensures that small vibrating motor 112-1 continues to be powered on and continues running for a short period of time after the coin hopper is detected as not being in operation.

In an embodiment, a speed of small vibrating motor 112-1 of apparatus 100 is adjustable via admin manager 313. Admin manager 313 provides a user interface for receiving a setting associated with the speed of small vibrating motor 112-1. The PCB 316 uses the setting when activating small vibrating motor 112-1.

In an embodiment, a sensor associated with PCB 316 senses the vibration intensity from small vibrating motor 112-1 along the coin media path and dynamically adjust the speed of small vibrating motor 112-1. In this way, the vibration intensity associated with apparatus 100 is self-calibrated. This self-calibration process is based on the principle of mechanical resonance, where the system incrementally adjusts the vibration frequency while monitoring the amplitude of mechanical vibrations. The optimal frequence is identified when the vibration amplitude reaches its maximum, indicating the coin chute's resonant frequency. This process ensures that the system operates at peak efficiency for the specific characteristics of each coin chute.

In an embodiment, a piezoelectric sensor associated with PCB 316 senses the vibration intensity from small vibrating motor 112-1 along the coin media path. This sensor is part of a feedback loop that dynamically adjusts the speed of small vibrating motor 112-1. The feedback loop operates by continuously monitoring the amplitude of mechanical vibrations detected by the piezoelectric sensor. As the vibration frequency is incrementally increased, the corresponding changes in vibration amplitude are monitored and tracked. The resonant or natural frequency of the coin chute is identified when the amplitude of mechanical vibration reaches its maximum. At this point, the vibration intensity associated with apparatus 100 is considered optimally calibrated. This self-calibration process ensures that the coin chute's resonant frequency operates optimally, maximizing the effectiveness of the coin media path agitation.

During a transaction at media terminal 310, controller 314 interacts with the terminal's coin dispenser 315 and other terminal modules or devices for purposes of performing a transaction on behalf of a customer. In an embodiment, the media terminal 310 is an ATM, an SST, or a point-of-sale (POS) terminal operated by a cashier on behalf of a customer checking out for a transaction.

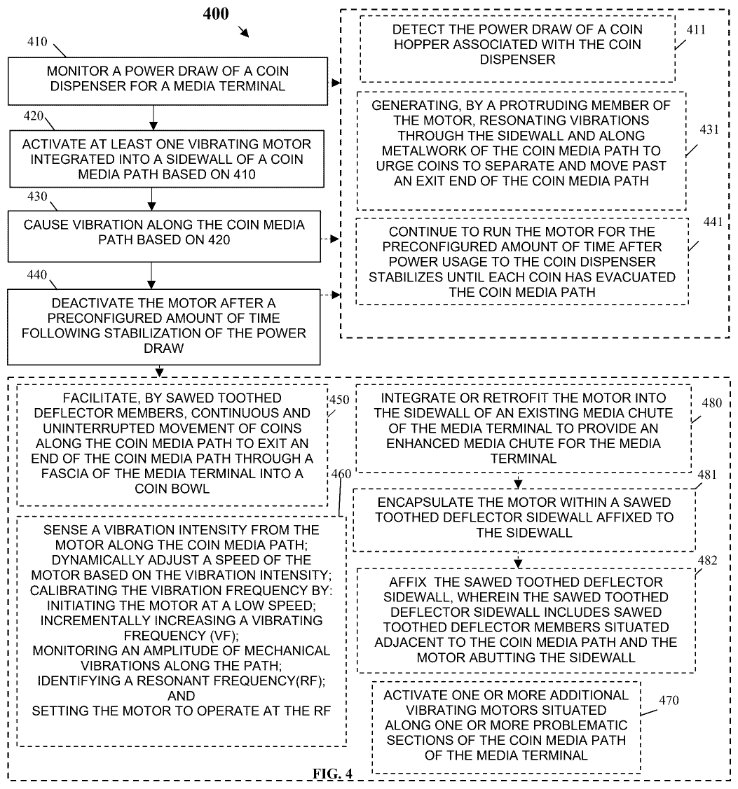

FIG. 4 is a flow diagram of a method 400 of operating a media terminal with coin media path agitation, according to an example embodiment. The method 400 can be executed via a specialized control circuit 316 or PCB 316 that detects power draw of a coin dispenser 315 of a media terminal 310 to control activation and deactivation of small vibrating motor 112-1 of apparatus 100. In an embodiment, the method 400 can be executed by a PCB 316 that includes software or firmware to control activation and deactivation of small vibrating motor 112-1 of apparatus 100.

At 410, a circuit or PCB 316 monitors a power draw of a coin dispenser 315 for a media terminal 310. In an embodiment, the power draw monitoring is performed completely without software or firmware being executed and is handled by a circuit 316 integrated into the power feed or coin dispenser 315.

In an embodiment, at 411, the circuit or PCB 316 detects the power draw of a coin hopper associated with the coin dispenser 315. This is an indication that the media terminal 310 has initiated and started a transaction for a customer at the media terminal 310 and modules or devices of the media terminal 310 are being powered up for the transaction.

At 420, the circuit or PCB 316 activates at least one vibration motor 112-1 integrated into a sidewall 123 of a coin media path 121 based on 410. At 430, the activation of the vibrating motor 112-1 causes vibration along the coin media path 121. In an embodiment, at 431, a protruding member 112-2 of vibrating motor 112-1 generates resonating vibrations through the sidewall 123 and along metalwork of the coin media path 121 to urge coins to separate and move past an exit end 120 of the coin media path 121.

At 440, the circuit or PCB 316 deactivates the vibrating motor 112-1 after a preconfigured amount of time following stabilization of the power draw. In an embodiment, at 441, the circuit or PCB 316 continues to run the vibrating motor 112-1 for the preconfigured amount of time after power usage to the coin dispenser 315 stabilizes and until each coin has evacuated the coin media path 121.

In an embodiment, at 450, sawed toothed deflector members 111 facilitate continuous and uninterrupted movement of coins along the coin media path 121 through a fascia of the media terminal 310 into a coin bowl. The coins are then collected by a customer associated with the transaction at the media terminal 310.

In an embodiment, at 460, the circuit or PCB 316 senses vibration intensity from the vibrating motor 112-1i along the coin media path 121 using input received from a piezoelectric sensor and a feedback loop. The circuit or PCB 316 dynamically adjusts a speed of the vibrating motor 112-1 based on the detected vibration intensity. The circuit or PCB 316 calibrates a vibration frequency of the motor 112-1 using the feedback loop. The feedback loop includes initiating the motor 112-1 at a low or an initial frequency; incrementally increasing a vibration frequency; monitoring an amplitude of mechanical vibrations along the coin media path using data or readings supplied from the piezoelectric sensor; identifying a resonant frequency of the coin media path when the amplitude of the mechanical vibrations reaches a maximum; and setting the motor 112-1 to operated at the resonant frequency.

In an embodiment, at 470, the circuit or PCB 316 activates one or more additional vibrating motors 112-1 situated along one or more problematic sections of the coin media path of the media terminal 310. The problematic sections are associated with gradient and turns along the coin media path where coins are getting stuck and not moving along to a coin box located on an exterior of a fascia associated with the media terminal 310.

In an embodiment, at 480, the vibrating motor 112-1 is integrated or retrofitted into the sidewall 123 of an existing media chute of the media terminal 310 to provide an enhanced media chute or apparatus 100 for the media terminal 310. In an embodiment, at 481, the vibrating motor 112-1 is encapsulated within a sawed toothed deflector sidewall 110 affixed to the sidewall 123. In an embodiment, at 482, the sawed toothed deflector sidewall 110 includes sawed toothed deflector members 111 situated adjacent to the coin media path 121 with the vibrating motor 112-1 abutting the sidewall 123.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
monitoring a power draw of a coin dispenser for a media terminal;
activating at least one vibrating motor integrated into a sidewall of a coin media path based on the monitoring;
causing vibration along the coin media path based on the activating; and
deactivating the at least one vibrating motor after a preconfigured amount of time following stabilization of the power draw.

2. The method of claim 1, further comprising:
facilitating, by sawed toothed deflector members of the sidewall, continuous and uninterrupted movement of coins along the coin media path to exit an end of the coin media path through a fascia of the media terminal into a coin bowl.

3. The method of claim 1, further comprising:
sensing a vibration intensity from the at least one vibrating motor along the coin media path using a piezoelectric sensor and a feedback loop;
dynamically adjusting a speed of the at least one vibrating motor based on the vibration intensity; and
calibrating a vibration frequency of the at least one vibrating motor using readings provided by the piezoelectric sensor and the feedback loop to:
initiate the at least one vibrating motor at a low frequency;
incrementally increase a vibration frequency;
monitor an amplitude of mechanical vibrations along the coin media path;
identify a resonant frequency of the coin media path when the amplitude of the mechanical vibrations reaches a maximum; and
set the at least one vibrating motor to operated at the resonant frequency.

4. The method of claim 1, further comprising:
activating one or more additional vibrating motors situated along one or more problematic sections of the coin media path of the media terminal.

5. The method of claim 1, further comprising:
integrating or retrofitting the at least vibrating motor into the sidewall of an existing media chute of the media terminal to provide an enhanced media chute for the media terminal.

6. The method of claim 5, wherein integrating or retrofitting further includes encapsulating the at least one vibrating motor within a sawed toothed deflector sidewall affixed to the sidewall.

7. The method of claim 6, wherein encapsulating further includes affixing the sawed toothed deflector sidewall, wherein the sawed toothed deflector sidewall includes sawed toothed deflector members situated adjacent to the coin media path with the at least one vibrating motor abutting the sidewall.

8. The method of claim 1, wherein monitoring further includes detecting the power draw of a coin hopper associated with the coin dispenser.

9. The method of claim 1, wherein causing further includes generating, by a protruding member of the at least one vibrating motor, resonating vibrations through the sidewall and along metalwork of the coin media path to urge coins to separate and move past an exit end of the coin media path.

10. The method of claim 1, wherein deactivating further includes continuing to run the at least one vibrating motor for the preconfigured amount of time after power usage to the coin dispenser stabilizes until each coin has evacuated the coin media path.

11. A coin media chute apparatus, comprising:
a sidewall of a coin media path;
at least one vibrating motor integrated into the sidewall; and
a control circuit configured to:
monitor a power draw of a coin dispenser for a media terminal;
activate the at least one vibrating motor based on the power draw;
cause vibration along the coin media path based on activation of the at least one vibrating motor; and
deactivate the at least one vibrating motor after a preconfigured amount of time following stabilization of the power draw.

12. The coin media chute apparatus of claim 11, wherein the sidewall comprises a sawed toothed deflector sidewall affixed to the sidewall, and wherein the sawed toothed deflector sidewall includes a plurality of sawed toothed deflector members configured to facilitate continuous and uninterrupted movement of coins along the coin media path to exit an end of the coin media path through a fascia of a media terminal and into a coin bowl.

13. The coin media chute apparatus of claim 12, wherein the at least one vibrating motor is encapsulated within the sawed toothed deflector sidewall with the at least one vibrating motor abutting an inside portion of the sidewall and behind the sawed toothed deflector members.

14. The coin media chute apparatus of claim 11, wherein the at least one vibrating motor is a 7 mm 5V DC coreless motor.

15. The coin media chute apparatus of claim 11, wherein the at least one vibrating motor further comprises a protruding member configured to rotated or vibrate against a backside of an inside portion of the sidewall when the at least one vibrating motor is provided power.

16. The coin media chute apparatus of claim 11, wherein the coin media path is located in a horizontal and narrow section just before a coin bowl located outside a fascia of a media terminal.

17. The coin media chute apparatus of claim 11, wherein the at least one vibrating motor is retrofitted into an existing coin chute of a media terminal to provide the coin media chute apparatus.

18. A system comprising:
a media terminal;
a coin dispenser integrated within the media terminal; and
a coin chute apparatus comprising:
a sidewall of a coin media path;
at least one vibrating motor integrated into the sidewall; and
a circuit configured to:
monitor a power draw of the coin dispenser;
activate the at least one vibrating motor based on the power draw;
cause vibration along the coin media path based on activation of the at least one vibrating motor; and
deactivate the at least one vibrating motor after a preconfigured amount of time following stabilization of the power draw.

19. The system of claim 18, wherein the sidewall comprises a sawed toothed deflector sidewall that is affixed to an inside of the sidewall, wherein the sawed toothed deflector sidewall encapsulates the at least one vibrating motor, wherein the sawed toothed deflector sidewall includes a plurality of sawed toothed deflector members configured to facilitate continuous and uninterrupted movement of coins along the coin media path through a fascia of the media terminal into a coin box.

20. The system of claim 18, wherein the media terminal is an automated teller machine (ATM), a self-service terminal (SST), a point-of-sale (POS) terminal.
